(19) United States
(12) Patent Application Publication
(10) Pub. No.: US 2018/0267968 A1
(43) Pub. Date: Sep. 20, 2018

(54) ONBOARD INFORMATION PROVISION DEVICE, INFORMATION PROVISION SYSTEM, AND INFORMATION PROVISION PROGRAM

(71) Applicant: HONDA MOTOR CO., LTD., Tokyo (JP)

(72) Inventor: Miyuki Shimota, Wako-shi (JP)

(73) Assignee: HONDA MOTOR CO., LTD., Tokyo (JP)

(21) Appl. No.: 15/924,877

(22) Filed: Mar. 19, 2018

(30) Foreign Application Priority Data
Mar. 17, 2017 (JP) 2017-052056

(51) Int. Cl. G06F 17/30; G06K 9/00; B60K 35/00

(52) U.S. Cl. CPC G06F 17/30032; G06K 9/00369; G06K 9/00268; B60K 2350/1096; B60K 35/00; B60K 2350/90; G06F 17/3005

(57) ABSTRACT

An onboard information provision device includes an occupant recognition part for recognizing an occupant riding on a vehicle, a personal information acquisition part for acquiring personal information corresponding to the recognized occupant from a personal information data base when permission has been obtained from the recognized occupant, and an information provision part for providing the occupant with provision information based on the acquired personal information.

### CROSS-REFERENCE OF RELATED APPLICATION

This application claims priority of Japanese Patent Application No. 2017-052056 filed in Japan on Mar. 17, 2017, the entire contents of which are incorporated herein by reference.

### TECHNICAL FIELD

The present invention relates to an onboard information provision device, an information provision system and an information provision program for providing the information to an occupant.

### BACKGROUND ART

Hitherto, there is known an onboard device which provides various information to a user (hereinafter, referred to as “occupant”) moving by a vehicle. Herein, the various information designates a content such as an entertaining content including music or moving/video image, and information on a destination to be recommended, for example.

In such onboard device, when the information corresponding to the occupant can be provided, instead of uniform provision of the information, it is possible to more satisfy the occupant. In this respect, an example of the art in the onboard device for providing the information corresponding to the occupant is disclosed in Japanese Patent Application Laid-Open Publication No. 2008-085945.

In the art disclosed in the above patent, it is disclosed that an occupant condition is detected by measurement by a device such as a face camera, a seating sensor, a blood pressure sensor or the like installed in the vehicle, and the operation of the onboard device is autonomously controlled in the form that is most desired (or seems to be desired) by the occupant from the detection results. For example, it is disclosed that a selection content of a music piece outputted in a car audio system is changed according to a physical condition and mental condition of the occupant, for example.

In the general art such as the art disclosed in the above patent, as referred to above, the information is provided based on a condition of the user which is detected from the result of measurement by the device installed in the vehicle. However, this is based merely on the result of measurement by the device installed in the vehicle, and the information which cannot be measured by the device installed in the vehicle has not been taken into consideration. Therefore, there may be cases where the appropriate information is not able to be provided with respect to each of occupants.

There are needs for solving the problems mentioned above and providing an onboard information provision device, an information provision system and an information provision program which provide information while considering also the information that cannot be measured by a device installed in a vehicle.

### SUMMARY OF INVENTION

(1) An onboard information provision device (for example, an onboard information provision device 30 to be referred to later) of one embodiment according to the present invention comprises an occupant recognition part (for example, an occupant recognition part 311 to be referred to later) for recognizing an occupant riding on a vehicle, a personal information acquisition part (for example, a communication part 312 and a permission part 313 to be referred to later) for acquiring personal information corresponding to the recognized occupant from a personal information data base when permission has been obtained from the recognized occupant, and an information provision part (for example, an information provision part 314 to be referred to later) for providing the occupant with provision information based on the acquired personal information.

(2) The onboard information provision device as defined in the above item (1), further comprises a storage part (for example, a storage part 315 to be referred to later) for storing the personal information while correlating it with the occupant, wherein the information provision part acquires personal information of the occupant who rides again on the vehicle, from the storage part when the occupant rides again on the vehicle, and provides the occupant who rides again on the vehicle with provision information based on the personal information acquired from the storage part.

(3) The onboard information provision device as defined in the above items (1) or (2), wherein the information provision part identifies relationship of plural occupants based on the personal information of the plural occupants when the occupants are more than one person, and selects the provision information to be provided, in accordance with the identified relationship.

(4) The onboard information provision device as defined in any one of the above items (1) to (3), wherein the information provision part selects the provision information to be provided, in accordance with a position of a seat on which the occupant is seated.

(5) The onboard information provision device as defined in any one of the above items (1) to (4), wherein the provision information to be provided by the information provision part is the information to recommend a destination.

(6) The onboard information provision device as defined in any one of the above items (1) to (5), wherein the provision information to be provided by the information provision part is a content consisting of either any of a still image, a moving image and a sound or combinations of these.

(7) An information provision system (for example, an information provision system 1 to be referred to later) of another embodiment according to the present invention comprises a data base preparation device (for example, a data base preparation device 20 to be referred to later), and an onboard information provision device as defined in any one of the above items (1) to (6), wherein the database preparation device prepares the personal information data base by collecting personal information of a user who may become an occupant, and the personal information acquisition part of the onboard information provision device acquires the personal information corresponding to the occupant from the personal information data base prepared by the data base preparation device.

(8) The information provision system as defined in the above item (7) further comprises a personal information acquisition device (for example, a personal information acquisition device 10 to be referred to later), wherein the personal information acquisition device acquires information on behavior of the user who may become the occupant and transmits the acquired information on the behavior of the user to the data base preparation device as the personal information of the user who may become the occupant, and the data base preparation device prepares the personal information database by collecting the personal information received from the personal information acquisition device.

(9) An information provision program of another embodiment according to the present invention for making a computer function as an onboard information provision device (for example, an information provision device 30 to be referred to later), wherein the information provision program makes the computer function as the onboard information provision device which comprises an occupant recognition part (for example, an occupant recognition part 311 to be referred to later) for recognizing an occupant riding on a vehicle, a personal information acquisition part (for example, a communication part 312 and a permission part 313 to be referred to later) for acquiring personal information corresponding to the recognized occupant from the personal information data base when permission has been obtained from the recognized occupant, and an information provision part (for example, an information provision part 314 to be referred to later) for providing the occupant with provision information based on the acquired personal information.

The word “part” used in certain elements such as an occupant recognition part, a personal information acquisition part, an information provision part, etc. may mean a physical part or component of computer hardware or any device including a controller, a processor, a memory, etc., which is particularly configured to perform functions and steps disclosed in the application.

### Effects of Embodiments of the Invention

According to embodiments of the present invention, it is possible to provide information while considering also the information that is not measured by a device installed in a vehicle.

### BRIEF DESCRIPTION OF THE DRAWINGS

FIG. 1 is a diagram showing a basic configuration of the whole of an embodiment of the present invention;

FIG. 2 is a block diagram showing function blocks of a personal information acquisition device in the embodiment of the present invention;

FIG. 3 is a block diagram showing function blocks of a data base preparation device in the embodiment of the present invention;

FIG. 4 is a table diagram showing an example of a personal information database prepared in the embodiment of the present invention;

FIG. 5 is a block diagram showing function blocks of an onboard information provision device in the embodiment of the present invention;

FIG. 6 is an image diagram showing a relationship between a vehicle and each of an occupant and the onboard information provision device in the embodiment of the present invention;

FIG. 7 is a flow chart showing a basic operation at the time of preparing a personal information data base in the embodiment of the present invention; and

FIG. 8 is a flow chart showing a basic operation at the time of providing the provision information based on the personal information in the embodiment of the present invention.

### DETAILED DESCRIPTION OF EMBODIMENTS OF THE INVENTION

### Outline of Embodiments of Present Invention

First, the outline of an embodiment of the present invention will be explained. In the embodiment of the present invention, an occupant riding on a vehicle is recognized by an onboard camera and the like, and personal information corresponding to the occupant is acquired from a personal information data base when permission has been obtained from the recognized occupant. Herein, the personal information is information relating to daily behavior of the occupant, for example, and includes the information which cannot be measured by a device installed in a vehicle.

Further, in this embodiment, the information based on the acquired personal information is provided to the occupant. Therefore, in this embodiment, the information can be provided while considering also the information which cannot be measured by the device installed in the vehicle, such as the information relating to the daily behavior of the occupant, and the like.

This is the outline of the embodiment of the present invention.

Hereinafter, the embodiment of the present invention will be explained in detail with reference to the accompanying drawings.

### Entire Configuration of Embodiment

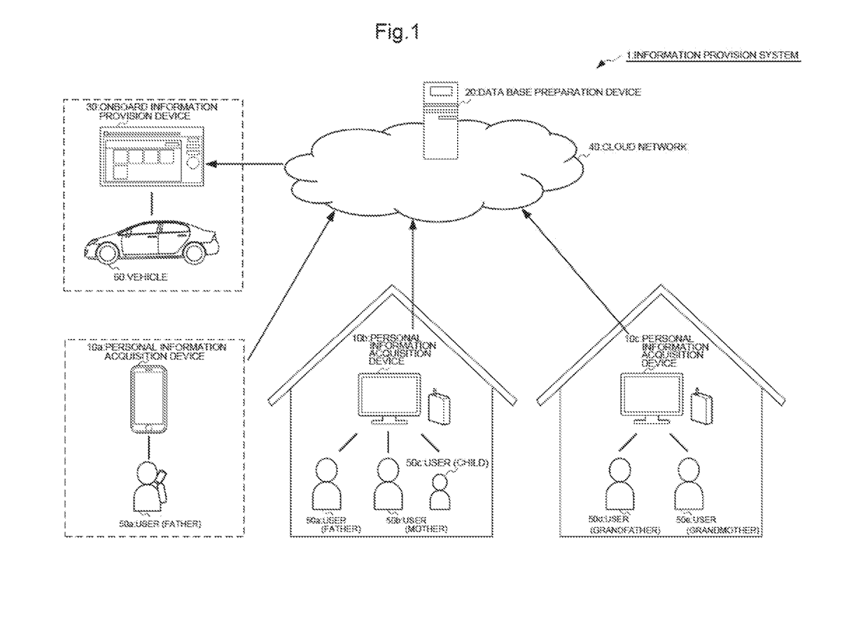

As seen in FIG. 1, an information provision system 1 is configured to include a plurality of personal information acquisition devices 10, a data base preparation device 20, an onboard information provision device 30, a cloud network 40, a plurality of users 50, and a vehicle 60.

The plurality of personal information acquisition devices 10 are devices for acquiring the personal information on each of the plurality of users 50. The personal information acquired by the plurality of personal information acquisition devices 10 is transmitted to the database preparation device 20 located on the cloud network 40. Herein, the personal information acquisition device 10 is realized by various devices and utilized by the user in various modes.

In the drawing, as an example, a personal information acquisition device 10a is realized by a portable terminal such as a smart phone, etc., and there is illustrated a case where the personal information on a user 50a who is a father of a user 50c is acquired by the personal information acquisition device 10a. Moreover, as another example, a personal information acquisition device 10b is realized by a household electric appliance, etc., and there is illustrated a case where the personal information on each of family members (the user 50a who is a father of the user 50c, a user 50b who is a mother of the user 50c, and the user 50c who is a child) is acquired by the personal information acquisition device 10b. Further, as a still another example, a personal information acquisition device 10c is realized by a household electric appliance, etc., and there is illustrated a case where the personal information on each of grandparents (the user 50d who is a grandfather of the user 50c, and a user 50e who is a grandmother of the user 50c) is acquired by the personal information acquisition device 10c. Herein, these use modes are only examples, and do not limit the use mode in this embodiment.

The cloud network 40 is a network for performing communication between the devices in this embodiment, and a communication system thereof and the like are not particularly limited. The cloud network 40 is realized for example by a network such as internet or portable telephone network, a network such as LAN (Local Area Network), and a network by combinations of these.

The data base preparation device 20 is a device which collects the personal information transmitted by the plurality of personal information acquisition devices 10 and prepares the data base of the personal information.

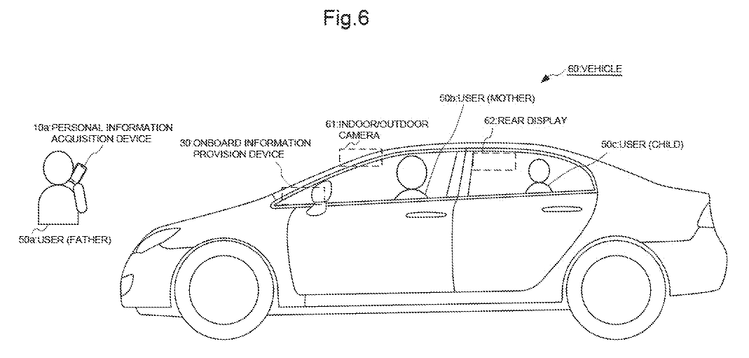

The onboard information provision device 30 is a device which is mounted on the vehicle 60 so as to be utilized by the user 50 and provides various kinds of information to the user 50 who is the occupant of the vehicle 60. Herein, in FIG. 1, only the vehicle is illustrated, and the illustration is omitted with respect to that the user 50 rides on the vehicle 60. That the user 50 rides on the vehicle 60 will be explained later with reference to FIG. 6. Incidentally, in the following explanation, the information to be provided by the onboard information provision device 30 to the user 50 who is the occupant of the vehicle 60 will be appropriately referred to as “provision information”.

Herein, as mentioned at the beginning, in this embodiment, in order to make the provision information more suitable for each of the occupants, the onboard information provision device 30 acquires the information corresponding to the occupant from the personal information data base created by the data base preparation device 20 and selects the content of the provision information based on the personal information in accordance with the occupant.

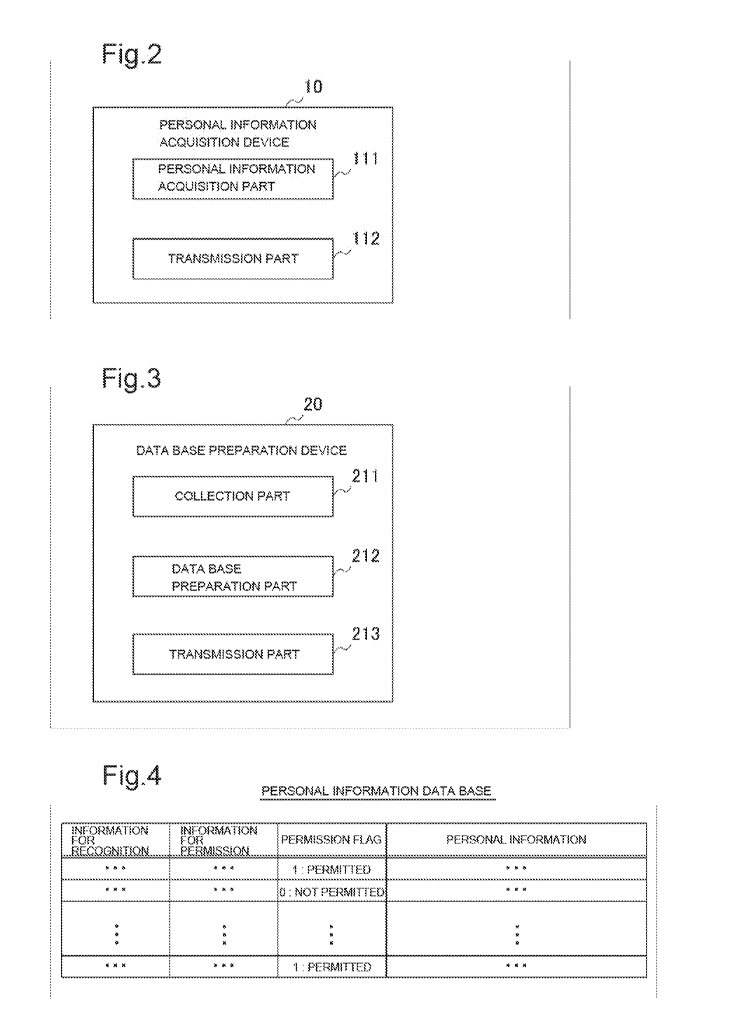

This is the entire configuration of this embodiment. Next, function blocks provided by each of these devices will be explained with reference to FIGS. 2 to 4.

### <Function Block of Personal Information Acquisition Device 10>

As seen in FIG. 2, the personal information acquisition device 10 is configured to include a personal information acquisition part 111 and a transmission part 112. Herein, since each of the plurality of personal information acquisition devices 10 is common in function in that it acquires and transmits the personal information, the explanation will be made while omitting final alphabets of reference characters, without distinguishing these personal information acquisition devices 10 in FIG. 2.

The personal information acquisition part 111 is a part for acquiring the personal information of the user 50 who utilizes the personal information acquisition device 10. For example, in the case where the personal information acquisition device 10 is realized by the smart phone or a wearable terminal like the personal information acquisition device 10a of FIG. 1, the personal information to be acquired is the information such as moving routes or passed shops, a purchase history of commodity in the shops, and life pattern information, with respect to the user 50. In this case, the personal information acquisition part 111 is realized by various kinds of sensors such as a GPS (Global Positioning System) sensor, an acceleration sensor, etc., application software using map information or application software controlling electronic money.

Further, for example, in the case where the personal information acquisition device 10 is realized by a communication device (for example, a gateway device) having the function of collecting the information stored by the electronic appliances such as the household electric appliances, etc., like the personal information acquisition device 10b and the personal information acquisition device 10c of FIG. 1., the personal information to be acquired is the information such as a use history of the household electric appliances, a use history of electric power, a browsing history of TV and DVD, a browsing history of the internet, other personal activity history of the family, and the relationship between the users each (for example, the users being in parent-child relationship, being in friendship relation or being a family in which a child has higher precedence than parents, etc.). In this case, the personal information acquisition part 111 is realized by the household electric appliance (the so-called “household appliance”), a camera installed within the house, a personal computer for using the internet or HEMS (Home Energy Management System) for managing energy to be used in the home.

The personal information acquisition part 111 outputs the acquired personal information together with the information for recognizing an individual (namely, the user 50) corresponding to this personal information, to the transmission part 121. In other words, the acquired personal information is outputted in such a manner that a person to which the personal information belongs is identified. Then, the transmission part 121 transmits the personal information and the information for recognizing the individual outputted by the personal information acquisition part 111 to the data base preparation device 20 through the cloud network 40.

Herein, these personal information as mentioned above are merely example, the information other than these personal information may be acquired as the personal information. For example, the user 50 may acquire the personal information in an SNS (Social Networking Service) such as “Facebook” (registered trademark), “instgram” (registered trademark), and the like which are utilized by using the smart phone or personal computer, and may transmit it to the data base preparation device 20. In this case, the personal information acquisition device 10 may be realized by a server device which provides these SNS services.

### <Function Block of Data Base Preparation Device 20>

Next, as seen in FIG. 3, the data base preparation device 20 is configured to include a collection part 211, a data base preparation part 212 and a transmission part 213. The collection part 211 receives the personal information and the information for recognizing the individual outputted by the each of the personal information acquisition devices, whereby to collect these information. Then, the collection part 211 outputs the collected personal information and information for recognizing the individual to the data base preparation part 212.

The data base preparation part 212 prepares the data base based on the personal information and the information for recognizing the individual outputted by the collection part 211. An example of configuration of the personal information data base will be explained referring to FIG. 4.

As seen in FIG. 4, the personal information data base includes, as attributes, “the information for recognition” for recognizing the individual collected by the collection part 211 in such a way as mentioned above, “the information for permission” for obtaining the use permission of the personal information from the user 50, “a permission flag” indicating whether or not the use permission of the personal information is obtained from the user 50, and “the personal information” which is collected by the collection part 211 in such away as mentioned above. Then, the database preparation part 212 prepares the personal information data base in such a way as to store the information corresponding to each of the attributes, in a field as a set for each of users 50. Herein, since the information used as the information for recognition and the information for permission is different in accordance with a method of information provision processing in the onboard information provision device 30, it will be explained in detail at the time of explaining the information provision processing.

The personal information data base prepared by the data base preparation part 212 is appropriately used by the onboard information provision device 30. Therefore, the data base preparation part 212 outputs the created personal information data base to the transmission part 213. Thereafter, the transmission part 213 outputs the personal information data base to the onboard information provision device 30.

### <Function Block of Onboard Information Provision Device 30>

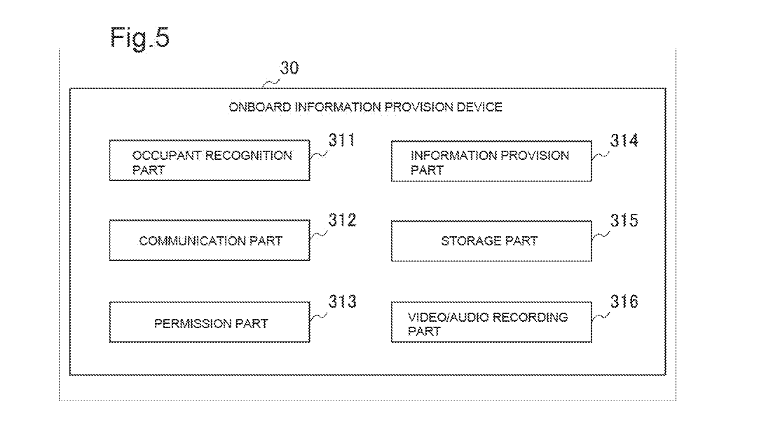

Next, as seen in FIG. 5, the onboard information provision device 30 is configured to include an occupant recognition part 311, a communication part 312, a permission part 313, an information provision part 314, a storage part 315, and a video and audio recording part 316.

Further, s seen in FIG. 6, the user rides on the vehicle 60 as an occupant. In addition, the onboard information provision device 30 is mounted in a position to be operable for example from a driver's seat or a passenger seat of the vehicle 60. Moreover, a camera 61 for imaging an interior and exterior of the vehicle 60 is mounted in the vicinity of a rearview mirror or a front window of the vehicle 60, for example. Further, a rear display 62 is mounted in a position to be seen from a rear seat of the vehicle 60, for example. These camera 61 and rear display 62 are connected to the onboard information provision device 30 by wire or radio and each perform communication with the onboard information provision device 30. In addition, other than these, an antenna, etc. for providing communication between the onboard information provision device 30 and the cloud network 40 may be installed in the vehicle 60, for example.

The onboard information provision device 30 is realized by a device which is mounted on and used for the vehicle 60 such as a four-wheeled motorcar or a two-wheeled motorcycle. For example, the onboard information provision device 30 is realized by a car navigation device fixed to the vehicle 60, and a PND (Portable Navigation Device) easily mounted on a dashboard, etc. of the vehicle 60. In this case, the onboard information provision device 30 may be provided with a car navigation function for performing route guidance from a present location to a destination. Herein, since the details of the car navigation function, the map information and the like for realizing the car navigation function are well known to persons skilled in the art, the detailed explanation thereof will be omitted.

The occupant recognition part 311 has a function for recognizing the occupant. Herein, the recognition of the occupant is performed by image recognition, for example. In this case, the occupant recognition part 311 communicates with the camera 61 through the communication part 312 to be referred to later, whereby to recognize the occupant on the inside of the vehicle 60 (for example, the user 50b and the user 50c illustrated in FIG. 6) or the occupant on the outside of the vehicle 60 (for example, the user 50a illustrated in FIG. 6) by the common image recognition technique. In this case, the information for recognition within the personal information data base is a data with respect to a feature amount of a face, etc. of each user 50.

Thereafter, the occupant recognition part 311 extracts the feature amount of the face, etc. of the occupant from the image imaged by the camera 61. Next, the occupant recognition part 311 transmits the acquired (extracted) feature amount to the data base preparation device 20 through the communication part 312 to be referred to later. The data base preparation device 20 compares the feature amount which is transmitted from the occupant recognition part 311 and the feature amount of each users 50, which is stored in the personal information data base as the information for recognition, whereby to recognize who the user 50 (namely, the occupant) corresponding to the feature amount transmitted from the occupant recognition part 311 is. Then, the data base preparation device 20 transmits the recognition result to the occupant recognition part 311. By the above processing, the recognition of the occupant by the image recognition technique can be realized. Herein, the image imaged by the camera 61 may be transmitted to the onboard information provision device 30, and the extraction of the feature amount from the image may be performed in the onboard information provision device 30.

Further, the comparison of the feature amounts may be performed in the onboard information provision device 30. In other words, the feature amounts of each user 50 stored in the personal information data base as the information for recognition may be downloaded to the onboard information provision device 30, whereby to perform the comparison between the downloaded feature amount and the feature amount of the occupant imaged by the camera 61.

Further, not only a unit occupant but also a position of the seat on which each of the occupants is seated may be recognized from the image imaged by the camera 61. For example, that the user 50a who is the father is seated on the driver's seat, that the user 50b who is the mother is seated on the passenger seat, and that the user 50c who is the child is seated on the rear seat may be recognized. Thus, the provision information may be provided while considering not only who the occupant is but also which seat the occupant is seated on.

Further, the occupant may be recognized by other method. For example, the occupant may be recognized by using the personal information acquisition device 10. In this case, the information for recognition within the personal information data base becomes the identification information of the personal information acquisition device 10 to be used by each of the users 50. Then, the communication part 312 communicates with the personal information acquisition device 10a carried by the user 50a in the example of FIG. 6, whereby the occupant recognition part 311 acquires the identification information of the personal information acquisition device 10a. For example, it is configured such that the identification information of the personal information acquisition device 10a is acquired, when having paired in compliance with short distance communication such as Bluetooth (registered trademark) and the like. Then, in the same way as the feature amount in the image recognition, the recognition of the occupant can be realized by comparing the acquired identification information of the personal information acquisition device 10a and the identification information of the personal information acquisition device 10 to be used by each user 50, stored as the information for recognition in the personal information data base.

The communication part 312 is a part in which the onboard information provision device 30 performs communication. The communication part 312 is realized, for example, by a module in which the onboard information provision device 30 performs communication with the data base preparation device 20 through the c loud network 40, a module for performing the short distance communication with the personal information acquisition device 10, and a module for performing communication with the camera 61, etc.

The Permission part 313 is a part for obtaining the permission from the occupant as to whether or not it is possible to use the personal information of the occupant itself. As a method for obtaining the permission, fingerprint authentication or authentication by a password is conceivable, for example. In this case, the information for permission within the personal information data base is the data of fingerprints or passwords corresponding to each of the users 50.

Further, the permission part 313 indicates guidance such as “Is personal information available? If the personal information is available, please perform fingerprint authentication.” or “Is personal information available? If the personal information is available, please input a password.” and prompts the fingerprint authentication or the input of the password.

Thus, the permission part 313, when the fingerprint data or the password is acquired, can perform the authentication by making a comparison between the acquired fingerprint data or the password and the fingerprint data or password corresponding to the occupant recognized in the occupant recognition part 311, which is stored as the information for permission in the personal information data base, in the same way as the comparison in the above image recognition. Then, if succeeded in the authentication, it is determined that the use permission of the personal information has been obtained from the user.

In this case, the permission flag of the personal information data base with respect to the occupant who succeeded in the authentication transitions from “0: not permitted” at the beginning to “1: permitted”. Accordingly, after that, that the permission is obtained is recognized merely by referring to the personal information data base without performing the authentication again. However, without doing so, the authentication may be preformed every time when using the onboard information provision device 30, so as to obtain the permission of the user.

Further, for example, when the occupant recognition part 311 has recognized the occupant by using the identification information of the personal information acquisition device 10, it may be determined that the permission has been obtained when having succeeded in the face authentication further. Moreover, the user performs previously the use permission in a house, etc. before riding on the vehicle, whereby it is possible to set previously the permission flag of the personal information data base to be “1: Permitted”.

Next, the information provision part 314 requests the personal information with respect to the occupant from which the use permission of the personal information is obtained, to the data base preparation device 20 through the communication part 312. The data base preparation part 20 acquires the personal information with respect to the occupant from which the use permission is obtained, from the personal information data base and transmits the acquired personal information to the information provision part 314. Herein, the personal information with respect to the occupant from which the use permission of the personal information is obtained may be transmitted directly to the onboard information provision device 30 not only from the data base preparation device 20 but also from the personal information acquisition device 10. For example, an example as illustrated in FIG. 6 may be configured such that the use permission of the personal information is obtained by the personal information acquisition device 10a and the personal information is transmitted directly to the onboard information provision device 30 from the personal information acquisition device 10a.

The information provision part 314 decides what kind of provision information is to be provided to the occupant, based on this personal information, and provides the decided provision information to the occupant. Therefore, the information provision part 314 has a display (not shown) for displaying an image, etc. as the provision information or a speaker (not shown) for outputting sound or the like, as a hardware configuration. Herein, the provision information may be provided, for example, from the rear display 62, the personal information acquisition device 10 which is paired with the onboard information provision device 30, and the like.

Incidentally, as regards the provision information to be provided, a recording medium such as CD, DVD and the like is inserted into the onboard information provision device 30, and a content data of the sound and moving image read from each of the recording mediums may be provided as the provision information. Moreover, when the function of a television tuner and antenna is added to the onboard information provision device 30, a television program received therefrom may be provided as the provision information.

Further, the provision information may be created based on a content data of music and moving image stored in the storage part 315 to be referred to later, a data of recommended locations, a data of the sounds and images recorded in the video and audio recording part 316 to be referred to later, and the like, and may be created based on the combinations of these data.

What kind of personal information is to be based on, and what kind of provision information is to be provided will be explained later, after explanation with respect to the storage part 315 and the video and audio recording part 316.

The storage part 315 is a memory device in which various kinds of data used by the onboard information provision device 30 are stored. For example, the personal information, with respect to the occupant from which the use permission is obtained, which is acquired by the information provision part 314 from the personal information data base of the data base preparation device 20 is stored in the storage part 315. With this configuration, it is not necessary to acquire all of the personal information from the data base preparation device 20 every time when using the onboard information provision device 30. In addition, in the storage part 315, there are further stored the content data of music and moving image, the data of the recommended locations, and the data of the sounds and images recorded in the video and audio recording part 316 to be referred to later.

The video and audio recording part 316 is a part for recording the sounds of the occupant and recoding the still image and moving image of the occupant. The recorded sound data and the recorded data of the still image and moving image are stored in the storage part 315 and used for creation of the provision information by the information provision part 314, for example. In this case, not the recorded sound data and the recorded data of the still image and moving image themselves but the feature amount of the sound and the image extracted from these data may be stored in the storage part 315. When only the feature amount is stored like this, it is possible to reduce an amount of the data. This feature amount can be used for the above mentioned recognition of the occupant and the like, for example.

In addition, the recording of the sounds may be performed by using a microphone (not shown) provided in an interior or exterior of the onboard information provision device 30. The recording of the images may be performed by using the camera 61, for example.

### <Explanation of Provision Information>

Next, the provision information provided by the information provision part 314 will be explained. It is conceivable that the following information is provided based on the personal information, as the provision information, for example. Typically, the provision information is information content(s) selected or determined based on personal/individual preference or experience of a recognized occupant, which can be identified in association with personal information of the occupant. The personal information may include any data, history or record indicating such personal/individual preference or experience. Further, the provision information appropriate for the occupant may be selected or determined in consideration of certain relationship between two or more occupants such as family members recognized in the vehicle.

For example, it is conceivable to provide the provision information based on the information of TV or DVD viewed and listened at home, which is contained in the personal information. In this case, when the TV or DVD viewed at home is in the middle of appreciation, it is conceivable to provide the continuation as the provision information. In addition, it may be possible to recommend a content relating to the TV or DVD appreciated at home.

Further, it is conceivable to provide the provision information based on the information on music listened at home and music in which the user interested in, which are contained in the personal information, for example. In this case, when there is the data of such music, the data may be reproduced. In addition, it may be possible to recommend the reproduction of such music.

Further, as mentioned above, in the case of being configured to recognize also the position of the seat on which each of the occupants is seated, it may be possible to provide the provision information corresponding to the seat position or to provide the recommendation corresponding to the seat position while taking also the seat position into consideration. For example, in the case where the user 50c who is a child is seated on the rear seat, the continuation of an animation program viewed at home may be provided as the provision information. In this case, the continuation of the animation program may be provided as the provision information from the rear display 62 located in a position easily visible from the rear seat, so that it is preferable since the user 50c who is a child is easy to see.

Further, other than the above, in the case where the user 50a who is a father is seated on the driver's seat and the user 50b who is a mother is seated on the passenger seat, such provision information that the user 50b who is a mother and tends to become bored since she does not drive is not bored may be provided. For example, the provision information may be provided based on the personal information of not the user 50a who is a father but the user 50b who is a mother.

Further, in the case where the relationship of the occupants is contained in the personal information of each of the occupants, the provision information corresponding to the relationship may be provided and the recommendation corresponding to the relationship may be provided while taking also the relationship into consideration. For example, a content of the user 50c who is a child may be provided as the provision information when there is a relationship in which a child has a higher precedence. For example, the provision information based on the personal information of not the user 50a who is a father but the user 50c who is a child may be provided. Moreover, when there is a relationship of husband and wife in which a mother (wife) has a higher precedence, a content of mother precedence may be provided. For example, the provision information based on the personal information of not the user 50a who is a father but the user 50b who is a mother may be provided.

Further, in the case of providing recommendation information on the destination as the provision information, a restaurant suitable for a couple may be recommended as the destination when it is recognized that the occupants are only a married couple, based on the relationship of the family, and a bookshop that the user 50a who is a father usually drops in may be recommended as the destination, based on the behavior history contained in the personal information of the user 50a who is a father. On the other hand, a family restaurant or recreation park suitable for a family may be recommended as the destination when a child is included in the occupants, based on the relationship of the family. Moreover, in the case where the users 50d and 50e who are grandparents and did not ride on the vehicle for a long time are further included in the occupants (in other words, when the family has met them for the first time in a while), a pleasant place or route which the family visited together with the grandparents in the past may be recommended as the destination.

Further, a memorial photograph in which the occupant is shown may be provided as the provision information. This photograph may be either a photograph contained in the personal information or a photograph taken by the video and audio recording part 316.

Further, in the case where the mental condition of the occupant can be determined by an image recognition technique, the provision information may be provided while taking a result of this mental condition into consideration. For example, when it is determined that the occupant is in an ill mode and when an atmosphere in the vehicle is serious, etc., a photograph at the time of going out in the past may be provided as the provision information.

### <Realization of Each Device>

Hereinabove, the function blocks provided in each of the devices (the personal information acquisition device 10, the data base preparation device 20, and the onboard information provision device 30) have been explained. Each of these devices is realized by embedding specific software of this embodiment in common devices.

More specifically, each of these devices has an operation processing unit such as CPU (Central Processing Unit), and the like. In addition, each of these devices has an auxiliary storage unit such as HDD (Hard Disk Drive) or SSD (Solid State Drive), etc. in which various kinds of programs are stored, and a main storage unit such as RAM (Random Access Memory) for storing a data which is transitorily required when the operation processing unit executes the program.

Further, in each of these devices, the operation processing unit reads various kinds of programs from the auxiliary storage unit and performs operation processing based on these various kinds of programs while developing the various kinds of read programs in the main storage unit.

Further, the function blocks as referred to below are realized by controlling the hardware of each of the devices based on the result of the operation. In other words, this embodiment can be realized by cooperation between the hardware and the software.

By the way, each of these devices has a display part formed of a liquid crystal display or an organic electroluminescence panel, etc., an input device such as a touch panel or a physical switch, etc. superposed on a display surface of the display part, and a general user interface such as a speaker or a microphone, etc., although illustration and explanation are omitted.

### Operation of Embodiment

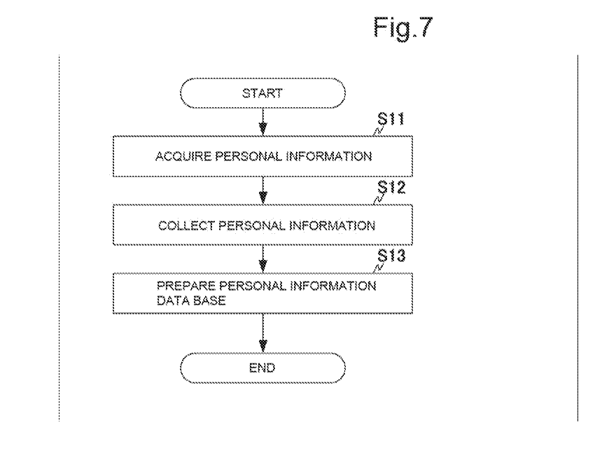

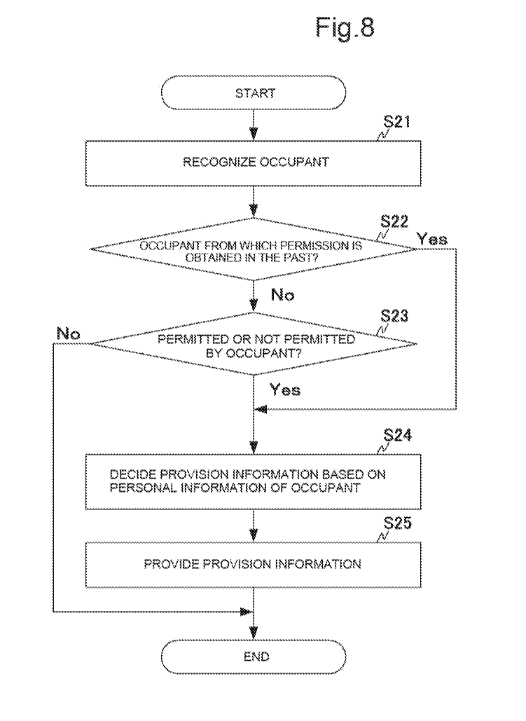

Hereinafter, the operation of this embodiment will be explained with reference to FIGS. 7 and 8. First, processing at the time of preparing the personal information data base will be explained while referring to a flow chard of FIG. 7.

The plurality of personal information acquisition devices 10 acquire the personal information with respect to each of the plurality of users 50 (Step S11). Then, the plurality of the personal information acquisition devices 10 transmit the acquired personal information to the data base preparation device 20.

Next, the data base preparation device 20 collects the personal information by receiving the personal information transmitted by the plurality of the personal information acquisition devices 10 (Step S12).

Further, the data base preparation device 20 creates the personal information data base based on the collected personal information (Step S13).

Thus, the personal information data base is prepared. The content of the personal information data base is enriched and renewed by repeatedly performing the processes from Step S11 to Step S13, so that more appropriate provision information may be provided.

Next, the operation of the onboard information provision device 30 at the time of providing the provision information will be explained while referring to a flow chart of FIG. 8.

First, the occupant is recognized by the occupant recognition part 311 (Step S21). Then, the permission part 313 determines whether or not the recognized occupant is the occupant who permits the use of the personal information in the past, by referring to the permission flag within the personal information data base of the data base preparation device 20 through the communication part 312 (Step S22).

Herein, when the recognized occupant is the occupant who permits the use of the personal information (Step 22: YES), the processing transitions to Step S24 without executing Step S23. On the other hand, when the recognized occupant is the occupant who does not permit the use of the personal information (Step 22: NO), the processing transitions to Step S23.

In Step S23, the permission part 313 prompts the occupant to permit the use of the personal information. However, when the use permission of the personal information is not obtained from the occupant (Step S23: NO), the processing is ended without providing the provision information based on the personal information. In this case, predetermined information not based on the personal information may be provided.

On the other hand, when the use permission of the personal information is obtained from the occupant (Step 23: YES), the processing transitions to Step S24.

In step S24, the information provision part 314 decides the content of the provision information based on the personal information of the occupant. Then, the information provision part 314 provides the provision information decided to provide information (Step S25).

According to the processing as explained above, this embodiment provides the occupant with the information based on the acquired personal information. Thus, in this embodiment, such an effect that it is possible to provide the information while considering the information such as the information relating to the daily behavior of the occupant or the like, which cannot be measured by the device installed in the vehicle, is performed.

### <Re Hardware and Software>

Further, each of the devices included in the above referred information provision system may be realized by either the hardware or the software, or combinations of these. In addition, also the navigation method which are performed by cooperation of each of the devices included in the above referred information provision system may be realized by either the hardware or the software, or combinations of these. Herein, what is realized by the software designates what is realized such that the computer reads and executes the program.

The program can be stored by using various kinds of non-transitory computer readable mediums and supplied to the computer. The non-transitory computer readable mediums include various kinds of tangible storage mediums. The non-transitory computer readable mediums include, for example, a magnetic recording medium (such as a flexible disc, a magnetic tape or a hard disc drive), a magneto-optical recording medium (such as a magneto-optical disc), CD-ROM (Read Only Memory), CD-R, CD-R/W, and a semiconductor memory (such as mask ROM, PROM (Programmable ROM), EPROM (Erasable PROM), flash ROM or RAM (Random Access Memory)). Further, the program can be supplied to the computer by various types of transitory computer readable mediums. The transitory computer readable medium includes, for example, an electric signal, an optical signal, and an electromagnetic wave. The transitory computer readable medium can supply the program to the computer through a wired communication path such as an electric wire, an optical fiber, etc. or a radio communication path.

While the preferred embodiment of the present invention has been explained, a scope of the present invention is not limited to the above referred embodiment, and the present invention may be embodied in such a configuration that various changes and modifications are made in the invention without departing from the true spirit of the present invention.

For example, in the above explanation while referring to FIG. 5, it is explained that the onboard information provision device 30 can be realized by the onboard devices such as the car navigation device fixed to the vehicle 60, and the PND (Portable Navigation Device) easily mounted on the dashboard, etc. of the vehicle 60.

By modifying this, the onboard information provision device 30 may be realized by allowing the onboard device and the portable device to cooperate with each other. In this case, the onboard device is connected to the portable device so as to transmit and receive the information by the radio communication conforming to the standard, such as Wi-Fi, NFC (Near Field Communication) and Bluetooth (registered trademark) or the wired communication through a USB (Universal Serial Bus) cable and the like.

In this condition, the portable device is remotely controlled by the operation of the onboard device. Moreover, the audio and video information is transmitted from the portable device to the onboard device.

Then, it is conceivable as an example that the audio and video information is received by the onboard device and the received audio and video information is reproduced and displayed in the display part of the onboard device. Further, it is conceivable as another example that the audio and video information is received by the onboard device and the received audio and video information is combined with the information of the onboard device thereby to reproduce and display the combined audio and video information in the display part of the onboard device. Herein, the audio and video information in such configuration may be the above referred provision information.

1. An onboard information provision device comprising:
an occupant recognition part configured to recognize an occupant riding on a vehicle to obtain information indicating an identity of the occupant;
a personal information acquisition part configured to, based on the information indicating the identity of the occupant, acquire personal information belonging to the recognized occupant from a personal information database when permission has been obtained from the recognized occupant; and
an information provision part configured to obtain or select provision information appropriate for the occupant based on the acquired personal information and provide the occupant with the provision information.

2. The onboard information provision device according to claim 1, further comprising a storage part configured to store the personal information in association with the occupant,
wherein the information provision part acquires personal information of the occupant w from the storage part when it is detected that the occupant rides again on the vehicle, and provides the occupant riding again on the vehicle with the provision information.

3. The onboard information provision device according to claim 1, wherein the information provision part is further configured to, when it is detected that plural occupants ride on the vehicle, identify relationship between the plural occupants based on the personal information of each occupant and select the provision information to be provided, in accordance with the identified relationship.

4. The onboard information provision device according to claim 1, wherein the occupant recognition part is further configured to detect a position of a seat on which the occupant is seated, and the information provision part selects the provision information to be provided to the occupant, in accordance with the detected position of the seat.

5. The onboard information provision device according to claim 1, wherein the provision information to be provided by the information provision part comprises recommendation of a vehicle destination.

6. The onboard information provision device according to claim 1, wherein the provision information to be provided by the information provision part comprises an image content, a video content, a sound content, and any combination thereof.

7. An information provision system comprising:
a database preparation device; and
an onboard information provision device according to claim 1,
wherein the data base preparation device is configured to collect personal information of potential users who may become an occupant and generate a personal information database containing the personal information of each user, and the personal information acquisition part of the onboard information provision device acquires the personal information of one of the users corresponding to the occupant from the personal information data base generated by the database preparation device.

8. The information provision system according to claim 7, further comprising:
a personal information acquisition device configured to acquire the personal information containing behavioral information of the users who may become the occupant and transmit the acquired personal information to the data base preparation device,
wherein the data base preparation device prepares the personal information data base by collecting the personal information from the personal information acquisition device.

9. A computer program containing instructions executable by a computer which is an onboard information provision device, the instructions defining the steps of:
recognizing an occupant riding on a vehicle to obtain information indicating an identity of the occupant;
based on the information indicating the identity of the occupant, acquiring personal information belonging to the recognized occupant from a personal information data base when permission has been obtained from the recognized occupant; and
obtaining or selecting provision information appropriate for the occupant based on the acquired personal information and providing the occupant with the provision information.
